(19) United States
(12) Patent Application Publication
(10) Pub. No.: US 2015/0067873 A1
(43) Pub. Date: Mar. 5, 2015

(54) INFORMATION PROCESSING DEVICE AND METHOD FOR LIMITING FUNCTION

(71) Applicant: FUJITSU LIMITED, Kawasaki-shi (JP)

(72) Inventors: Hideto KIHARA, Kawasaki (JP); Junichi Yura, Yokohama (JP); Takashi Ohno, Kobe (JP)

(73) Assignee: FUJITSU LIMITED, Kawasaki-shi (JP)

(21) Appl. No.: 14/331,560

(22) Filed: Jul. 15, 2014

(30) Foreign Application Priority Data
Sep. 5, 2013 (JP) 2013-184403

(51) Int. Cl. G06F 21/60

(52) U.S. Cl. CPC G06F 21/60
USPC 726/26

(57) ABSTRACT

An information processing device includes, a processor; and a memory which stores a plurality of instructions, which when executed by the processor, cause the processor to execute, determining, when an execution of one of a first application and a second application is requested, an execution state of the other of the first application and the second application; and limiting a function of the requested application based on the execution state of the other application.

### CROSS-REFERENCE TO RELATED APPLICATION

This application is based upon and claims the benefit of priority of the prior Japanese Patent Application No. 2013-184403 filed on Sep. 5, 2013, the entire contents of which are incorporated herein by reference.

### FIELD

The embodiments discussed herein are related to an information processing device, a function limiting program, and a method for limiting a function.

### BACKGROUND

Bring your own device (BYOD), a policy of permitting employees of companies to use personally owned information processing devices such as smart phones for the companies tends to be widely used. The information processing devices used in BYOD are devices owned by the employees. Thus, private applications and private data that are personally used by the employees are stored in the information processing devices. In addition, corporate applications and corporate data that are used for work by the employees are stored in the information processing devices in some cases. Thus, for BYOD, security for the information processing devices is requested to be secured.

As a technique for securing security for information processing devices, there is a technique for switching between an available private application and an available corporate application by switching between policies using mobile device management (MDM) software. In addition, there is a technique for using a secure container to partition a corporate environment in which corporate data and corporate applications are executed, requesting authentication for use of the corporate environment, and executing the corporate data and the corporate applications in the corporate environment only if the authentication is successful, for example. Such conventional techniques for securing security for information processing devices are disclosed in, for example, Japanese Laid-open Patent Publication Nos. 2004-127280, 2010-97594, and 2010-141705 and International Publication Pamphlet No. WO2009/110275.

### SUMMARY

In accordance with an aspect of the embodiments, an information processing device includes, a processor; and a memory which stores a plurality of instructions, which when executed by the processor, cause the processor to execute, determining, when an execution of one of a first application and a second application is requested, an execution state of the other of the first application and the second application; and limiting a function of the requested application based on the execution state of the other application.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a diagram illustrating a functional configuration of an information processing device according to a first embodiment;

FIG. 2 is a diagram illustrating an example of a data configuration of an application type table;

FIG. 3 is a diagram illustrating an example of a data configuration of an executed application management table;

FIG. 4 is a diagram illustrating an example of a data configuration of a limiting requirement table;

FIG. 5 is a diagram illustrating an example of a data configuration of an access application management table;

FIG. 6 is a diagram illustrating an example of a data configuration of an access API management table;

FIG. 7 is a diagram illustrating an example of the flow of a function limiting process;

FIG. 8 is a diagram illustrating an example of the flow of an update process;

FIG. 9 is a diagram illustrating an example of the flow of a process of forcibly terminating an application;

FIG. 10 is a diagram illustrating a functional configuration of the information processing device according to a second embodiment; and

FIG. 11 is a diagram illustrating a computer configured to execute a function limiting program.

### DESCRIPTION OF EMBODIMENTS

Hereinafter, embodiments of an information processing device disclosed herein, a function limiting program disclosed herein, and a method, disclosed herein, for limiting a function are described with reference to the accompanying drawings. This disclosure is not limited to the embodiments. The embodiments may be combined without contradicting details of processes.

### First Embodiment

(Configuration of Information Processing Device)

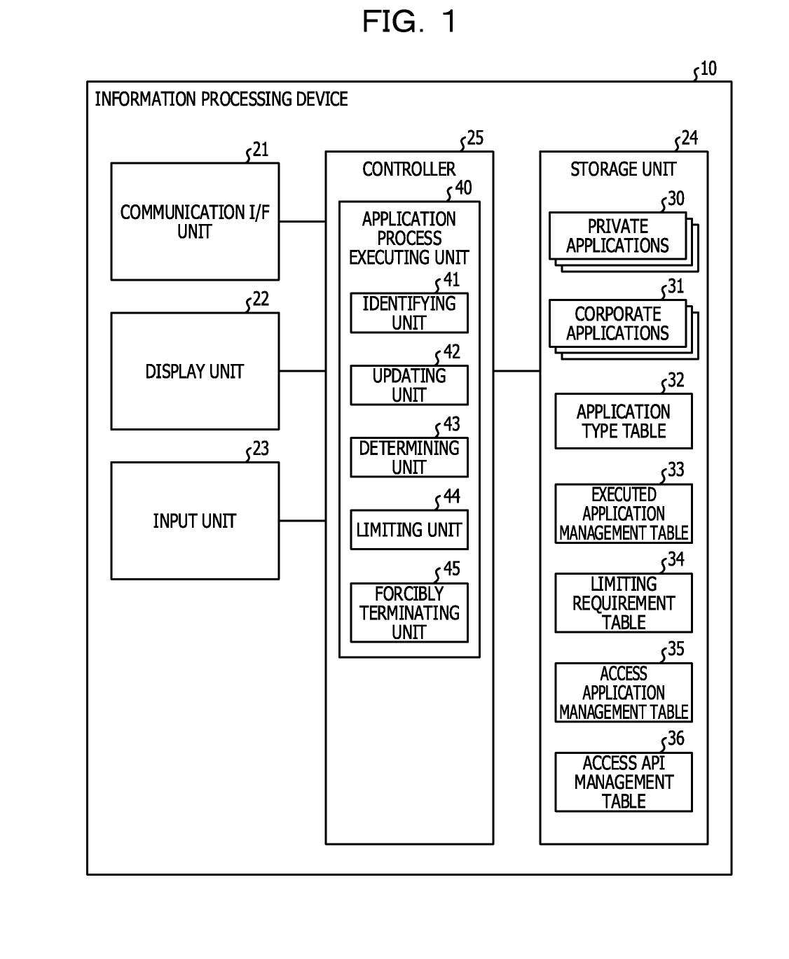

An information processing device according to a first embodiment is described. FIG. 1 is a diagram illustrating a functional configuration of the information processing device according to the first embodiment. The information processing device 10 is a terminal device personally owned by a user who is, for example, an employee of a company. The information processing device 10 is, for example, a mobile terminal device such as a smart phone, a personal digital assistant (PDA), or a mobile phone. The information processing device 10 may be a device such as a desktop personal computer (PC), a tablet PC, or a laptop PC. The user uses the information processing device 10 for private and for work for the company. Specifically, the user uses the information processing device 10 in BYOD.

As illustrated in FIG. 1, the information processing device 10 includes a communication interface (I/F) unit 21, a display unit 22, an input unit 23, a storage unit 24, and a controller 25. The information processing device 10 may include the same functional units as known mobile terminal devices and known PCs as well as the functional units illustrated in FIG. 1. For example, the information processing device 10 may include an antenna, a carrier communication unit for executing communication through a carrier network, and a global positioning system (GPS) receiver.

The communication interface unit 21 is an interface for controlling communication with another device. The communication interface unit 21 transmits and receives information of various types to and from the other device. For example, the communication interface unit 21 transmits and receives, through a network (not illustrated), data of various types to and from an in-house system of the company to which the user belongs. An example of the communication interface unit 21 is a network interface card such as a LAN card.

The display unit 22 is a display device for displaying information of various types. The display unit 22 is a display device such as a liquid crystal display (LCD) or a cathode ray tube (CRT). The display unit 22 displays information of various types.

The input unit 23 is an input device for inputting information of various types. The input unit 23 is an input device such as a mouse, a keyboard, buttons installed in the information processing device 10, a transparent touch sensor installed on the display unit 22, or the like. Various operations by the user are input in the input unit 23. For example, various operations for various applications installed in the information processing device 10 are input in the input unit 23. In the example of FIG. 1, since the functional configuration is illustrated, the display unit 22 and the input unit 23 are separated from each other. For example, the display unit 22 and the input unit 23 may be unified to form a device such as a touch panel.

The storage unit 24 is a storage device such as a solid state drive (SSD) or an optical disc. The storage unit 24 may be a data-rewritable semiconductor memory such as a random access memory (RAM), a flash memory, or a nonvolatile static random access memory (NVSRAM).

The storage unit 24 has, stored therein, an operating system (OS) to be executed by the controller 25 and various programs to be used for function limiting. In addition, the storage unit 24 has, stored therein, various types of data to be used for programs to be executed by the controller 25. For example, the storage unit 24 has, stored therein, private applications 30 (i. e., first application 30) and corporate applications 31 (i. e., second application 31). Furthermore, the storage unit 24 has, stored therein, an application type table 32, an executed application management table 33, a limiting requirement table 34, an access application management table 35, and an access application program interface (API) management table 36. The storage unit 24 may have, stored therein, various types of data other than the aforementioned programs, the aforementioned data, the aforementioned applications, and the aforementioned tables.

The private applications 30 (i. e., first application 30) are software to be personally used by the user. The corporate applications 31 (i. e., second application 31) are software to be used for work by the user. For example, the user manages a corporate schedule using corporate schedule software such as Exchange Server and manages a private schedule using private schedule software such as Google Calendar. In this case, the software such as Google Calendar corresponds to a private application 30 and the software such as Exchange Server corresponds to a corporate application 31.

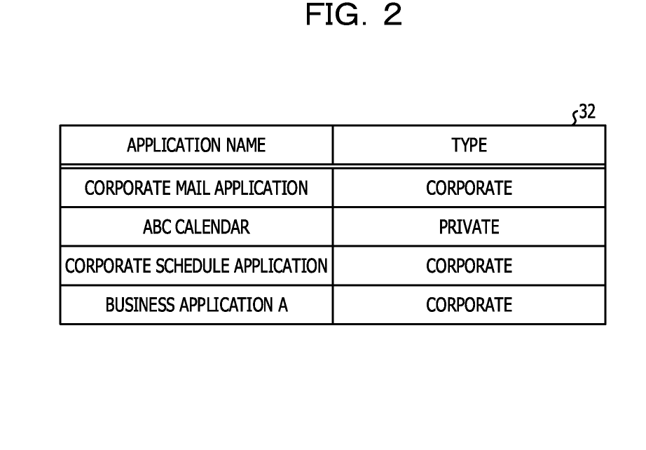

The application type table 32 is a table in which information that indicates whether software that is executed by the information processing device 10 is a corporate application 31 or a private application 30 is registered. In the present embodiment, information of the private applications 30 and the corporate applications 31 is stored in the application type table 32. FIG. 2 is a diagram illustrating an example of a data configuration of the application type table. As illustrated in FIG. 2, the application type table 32 includes an “application name” item and a “type” item. The “application name” item is a region for storing identification information that identifies the applications. In the present embodiment, the names of the applications are stored as the identification information in the “application name” item. The “type” item is a region for storing information that indicates whether each of the applications of which the names are stored in the “application name” item is a corporate application 31 or a private application 30. If the application is a corporate application 31, “corporate” is stored in the “type” item. If the application is a private application 30, “private” is stored in the “type” item.

The example of FIG. 2 indicates that the type of an application with a name “ABC Calendar” is “private” and the application “ABC Calendar” is a private application 30.

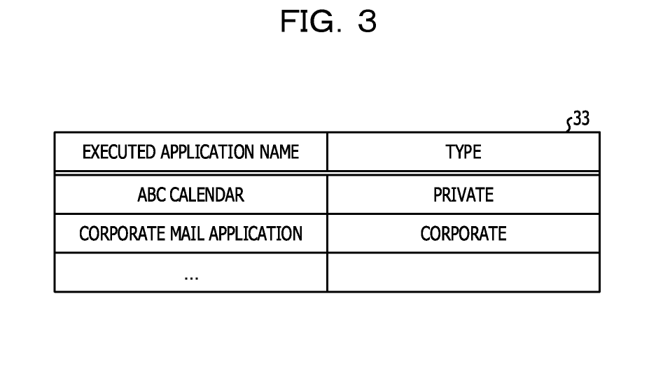

The executed application management table 33 is a table for storing information of an application that is being executed in the information processing device 10. FIG. 3 is diagram illustrating an example of a data configuration of the executed application management table 33. As illustrated in FIG. 3, the executed application management table 33 includes an “executed application name” item and a “type” item. The “executed application name” item is a region for storing identification information that identifies applications that are being executed in the information processing device 10. In the present embodiment, the names of the applications that are being executed are stored in the “executed application name” item. The “type” item is a region for storing information that indicates whether each of the applications of which the names are stored in the “executed application name” item is a corporate application 31 or a private application 30. For example, if the application is a corporate application 31, “corporate” is stored in the “type” item. If the application is a private application 30, “private” is stored in the “type” item.

The example illustrated in FIG. 3 indicates that the application with the name “ABC Calendar” is being executed and is the private application 30 since the type of the application with the name “ABC Calendar” is “private”.

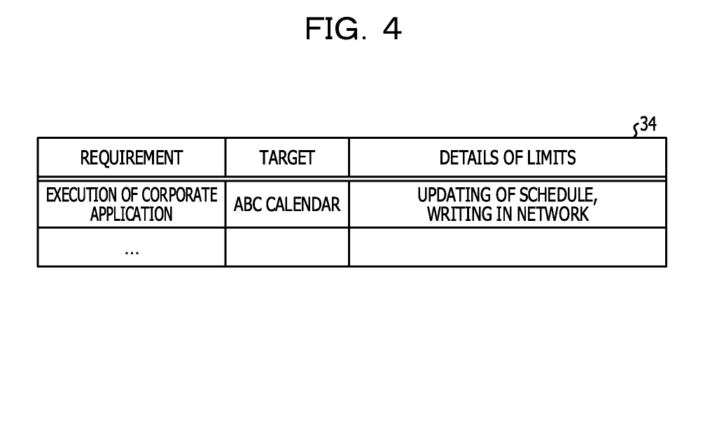

The limiting requirement table 34 is a table in which a requirement for limiting a function of an application is registered. FIG. 4 is a diagram illustrating an example of a data configuration of the limiting requirement table. As illustrated in FIG. 4, the limiting requirement table 34 includes a “requirement” item, a “target” item, and a “details of limits” item. The “requirement” item is a region for storing a requirement for limiting a function. The “target” item is a region for storing identification information of software of which the function is to be limited. In the present embodiment, the name of the software of which the function is to be limited is stored in the “target” item. The “details of limits” item is a region for storing information indicating a detail of the function to be limited.

In the example illustrated in FIG. 4, information that indicates that functions of the software ABC Calendar that are updating of a schedule and writing in the network are limited during the execution of a corporate application as a requirement is registered. Although the example of FIG. 4 indicates that details of the functions to be limited are described in the “details of limits” item in order to easily understand the functions to be limited, the names of functions such as APIs to be called in order to execute the functions to be limited or the like are stored in the “details of limits” item in fact.

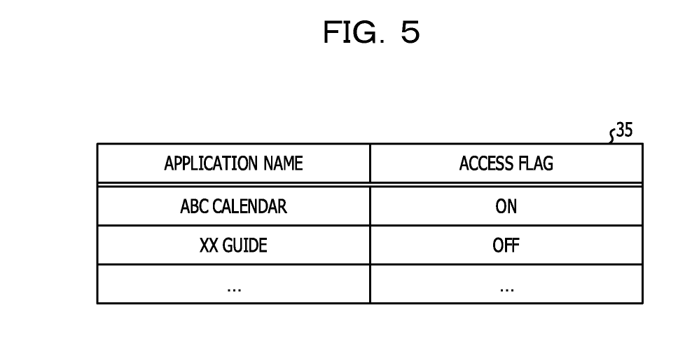

The access application management table 35 is a table for storing information of software that may have accessed corporate data. FIG. 5 is a diagram illustrating an example of a data configuration of the access application management table. As illustrated in FIG. 5, the access application management table 35 includes an “application name” item and an “access flag” item. The “application name” item is a region for storing identification information that identifies applications. In the present embodiment, the names of the applications are stored in the “application name” item. The “access flag” item is a region for storing information indicating whether or not software with the application names has accessed corporate data. If software with a name stored in the “application name” item has accessed corporate data, “ON” is stored in the “access flag” item. If the software with the name stored in the “application name” item does not access corporate data, “OFF” is stored in the “access flag” item.

The example illustrated in FIG. 5 indicates that an access flag for the software ABC Calendar represents “ON” and thus the software ABC Calendar has accessed corporate data.

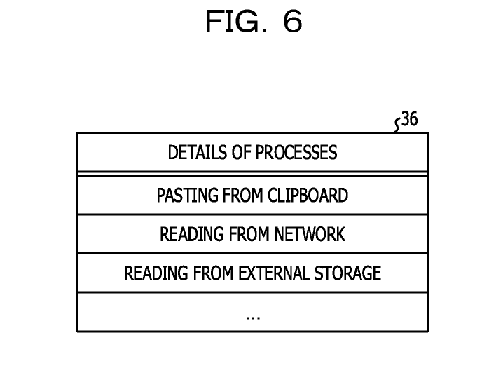

The access API management table 36 is a table in which the name of a function such as an API that enables corporate data to be accessed or the like is registered. FIG. 6 is a diagram illustrating an example of a data configuration of the access API management table. As illustrated in FIG. 36, the access API management table 36 includes a “details of processes” item. The “details of processes” item is a region for storing information of functions of software that is able to access corporate data. Although the example illustrated in FIG. 6 indicates that details of the functions of the software that is able to access corporate data are described in the “details of processes” item in order to easily understand registered details of processes, the names of functions such as APIs of the software that is able to access corporate data or the like are stored in the “details of processes” item in fact.

In the example illustrated in FIG. 6, pasting from a clipboard, reading from a network, and a reading from an external storage are registered. When corporate data is stored in the clipboard, the corporate data may be accessed by pasting. Thus, the pasting from the clipboard is registered as an API that enables the corporate data to be accessed. If the corporate data is stored in an external device connected to the network, the reading of data from the network may cause the corporate data to be accessed. Thus, the reading from the network is registered as an API that enables the corporate data to be accessed. If the corporate data is stored in the external storage, the reading of data from the external storage may cause the corporate data to be accessed. Thus, the reading from the external storage is registered as an API that enables the corporate data to be accessed.

Returning to FIG. 1, the controller 25 is a device configured to control the information processing device 10. As the controller 25, an electronic circuit such as a central processing unit (CPU) or a micro processing unit (MPU) or an integrated circuit such as an application specific integrated circuit (ASIC) or a field programmable gate array (FPGA) may be used. The controller 25 has an internal memory for storing control data and programs defining various procedures for processes. The controller 25 uses the programs and the control data to execute the various processes. The controller 25 functions as various processing units by executing the various programs. For example, the controller 25 has an application process executing unit 40. The controller 25 may have a processing unit other than the aforementioned processing units.

The application process executing unit 40 controls the execution of processes of software of various types. For example, when the application process executing unit 40 is instructed to execute any of the private applications 30 and the corporate applications 31, the application process executing unit 40 controls the execution of the application 30 or 40 instructed to be executed. In addition, the application process executing unit 40 may simultaneously execute a private application 30 and a corporate application 31. The application process executing unit 40 has an identifying unit 41, an updating unit 42, a determining unit 43, a limiting unit 44, and a forcibly terminating unit 45 in order to suppress a reduction in security when the application process executing unit 40 simultaneously executes a private application 30 and a corporate application 31. If the applications call an API of the OS executed by the controller 25, the identifying unit 41, the updating unit 42, the determining unit 43, the limiting unit 44, and the forcibly terminating unit 45 are installed as software for the OS. On the other hand, if the applications are HTML5 applications, the identifying unit 41, the updating unit 42, the determining unit 43, the limiting unit 44, and the forcibly terminating unit 45 are installed in infrastructure software for executing HTML5 applications.

The identifying unit 41 identifies various facts. For example, when an application is instructed to be executed, the identifying unit 41 identifies, based on the application type table 32, whether the application instructed to be executed is a private application 30 or a corporate application 31. In the present embodiment, information of the private applications 30 and the corporate applications 31 is stored in the application type table 32. Information of either the private applications 30 or the corporate applications 31 may be stored in the application type table 32. In this case, if information of the application instructed to be executed is not stored in the application type table 32, the identifying unit 41 identifies that the application instructed to be executed is a private or corporate application of which information is not stored in the application type table 32.

The updating unit 42 updates data of various types. For example, the updating unit 42 registers, in the executed application management table 33, information of an application instructed to be executed and identified to be a private application 30 or a corporate application 31 by the identifying unit 41. In addition, the updating unit 42 deletes, from the executed application management table 33, information of an application terminated.

The updating unit 42 registers, in the access application management table 35, a private application 30 that may have accessed corporate data to be used for work by the user. For example, when a private application 30 that is being executed executes a process of a function name registered in the access API management table 36, the updating unit 42 registers the private application 30 in the access application management table 35 so as to ensure that an access flag for the private application 30 represents “ON”. The updating unit 42 may register a private application 30 that is being executed in the access application management table 35 so as to ensure that an access flag for the private application 30 represents “OFF”, and the updating unit 42 may update, to “ON”, an access flag for a private application 30 that has executed a process of a function name registered in the access API management table 36. Thus, the updating unit 42 causes information of a private application 30 that may have accessed corporate data to be stored in the access API management table 36 so as to ensure that an access flag for the private application 30 represents “ON”.

The determining unit 43 determines various facts. For example, if a request to execute a certain private application 30 or a certain corporate application 31 is provided, the determining unit 43 determines an execution state of the other private or corporate application 30 or 31. For example, if the request to execute a certain private corporation 30 or a certain corporate application 31 is provided, the determining unit 43 identifies whether or not the other private or corporate application 30 or 31 has been registered in the executed application management table 33.

The limiting unit 44 limits various facts. For example, the limiting unit 44 limits a function of the requested private or corporate application based on the execution state of the other application determined by the determining unit 43. Specifically, if the certain private or corporate application 30 or 31 is instructed to be executed, the limiting unit 44 limits the execution of a process of the certain application or limits a function of the certain application based on the execution state of the other application. For example, the limiting unit 44 limits, as the limit on the function, at least any of reading and writing of data by the certain application. The limiting of the reading of data may be to prohibit the reading of data. The limiting of the reading of data may be to limit the amount of data that is able to be read. The limiting of the writing of data may be to prohibit the writing of data. The limiting of the writing of data may be to limit the amount of data that is able to be written. For example, if a process of a function name registered in the “details of limits” item is executed in a state in which a requirement registered in the limiting requirement table 34 is satisfied, the limiting unit 44 limits the execution of the process of the function name. For example, if the limiting requirement table 34 has data illustrated in FIG. 4, and a corporate application 31 and ABC Calendar as a private application 30 are simultaneously executed, the limiting unit 44 prohibits updating of a schedule and writing in the network. In this manner, the limiting unit 44 may secure the security by prohibiting the private applications 30 from updating and writing data.

The function limiting by the limiting unit 44 is not limited to prohibition of the execution of a process of a function called. For example, for a referencing-related API for reading data, the limiting unit 44 may make read data blank. Thus, the limiting unit 44 may not treat a process as an abnormality and may cause a private application 30 to recover the process. The limiting unit 44, therefore, may suppress the fact that the process of the private application 30 becomes abnormal. For example, when a private application 30 acquires information such as the latest news and displays the acquired information using Really Simple Syndication (RSS), the limiting unit 42 prohibits the private application 30 from reading data, and a process is recovered while being treated as an abnormality, the process of the private application 30 becomes abnormal. In this case, the limiting unit 44 may make read data blank and thereby suppress the fact that the process of the private application 30 becomes abnormal. In addition, the limiting unit 44 may delay returning of a process result. Thus, the limiting unit 44 may make a private application 30 difficult to be used and may make the user concentrate on tasks of the user. The limiting unit 44 may limit the amount of data that is able to be read to a predetermined amount or less. After a private application 30 reads data a predetermined number of times, the limiting unit 44 may return the same result for reading next executed by the private application 30. As the number of times of the reading increases, the limiting unit 44 may gradually reduce the amount of data to be returned. As the number of times of the reading increases, the limiting unit 44 may gradually increase the amount of a blank portion of data and return the data with the blank portion. Thus, the limiting unit 44 may make the private application 30 difficult to be used and may make the user concentrate on the tasks of the user.

For example, for an updating-related API for writing data, the limiting unit 44 may limit the amount of data able to be written to a predetermined amount or less and enable data to be written. For example, the limiting unit 44 may permit writing of data of several rows in a schedule. Thus, the user may use a private application 30 such as private schedule software to register a schedule even during the execution of a corporate application 31, and the usability of the information processing device 10 may be improved. The limiting unit 44 may make data blank and enable the data to be written. Thus, the user may use a private application 30 such as the private schedule software to leave a history record, indicating that a schedule is registered using blank data, even during the execution of a corporate application 31. The usability, therefore, may be improved.

For example, the types of the applications may not be the two types, corporate and private. Each of the types may be at multiple levels, and the limiting unit 44 may limit a function based on the levels. For example, for the corporate applications 31, multiple security levels such as security levels 1 and 2 may be provided. If a security level of a corporate application 31 that is being executed is 1, the limiting unit 44 may permit the corporate application 31 to reference data and may prohibit the corporate application 31 from updating data. If the security level of the corporate application 31 that is being executed is 2, the limiting unit 44 may prohibit the corporate application 31 from referencing and updating data. In addition, for the private applications 30, security levels such as security levels 1 and 2 may be provided, for example. If a security level of a private application 30 that is being executed is 2, the limiting unit 44 may permit the execution of the corporate applications 31. If the security level of the private application 30 that is being executed is 1, the limiting unit 44 may prohibit the execution of the corporate applications 31. If a plurality of applications are being executed, the lowest security level among the applications may be used as a security level of the overall applications, or an average of the security levels of the applications may be used as the security level of the overall applications.

The forcibly terminating unit 45 forcibly terminates an application. For example, when a corporate application 31 executed is terminated, the forcibly terminating unit 45 references the access application management table 35. Then, the forcibly terminating unit 45 forcibly terminates a private application 30 of which information has been stored in the access application management table 35 and for which an access flag represents “ON” in the access application management table 35. Thus, the forcibly terminating unit 45 may suppress the fact that corporate data remains held in a storage region used by a private application 30 that may have accessed corporate data.

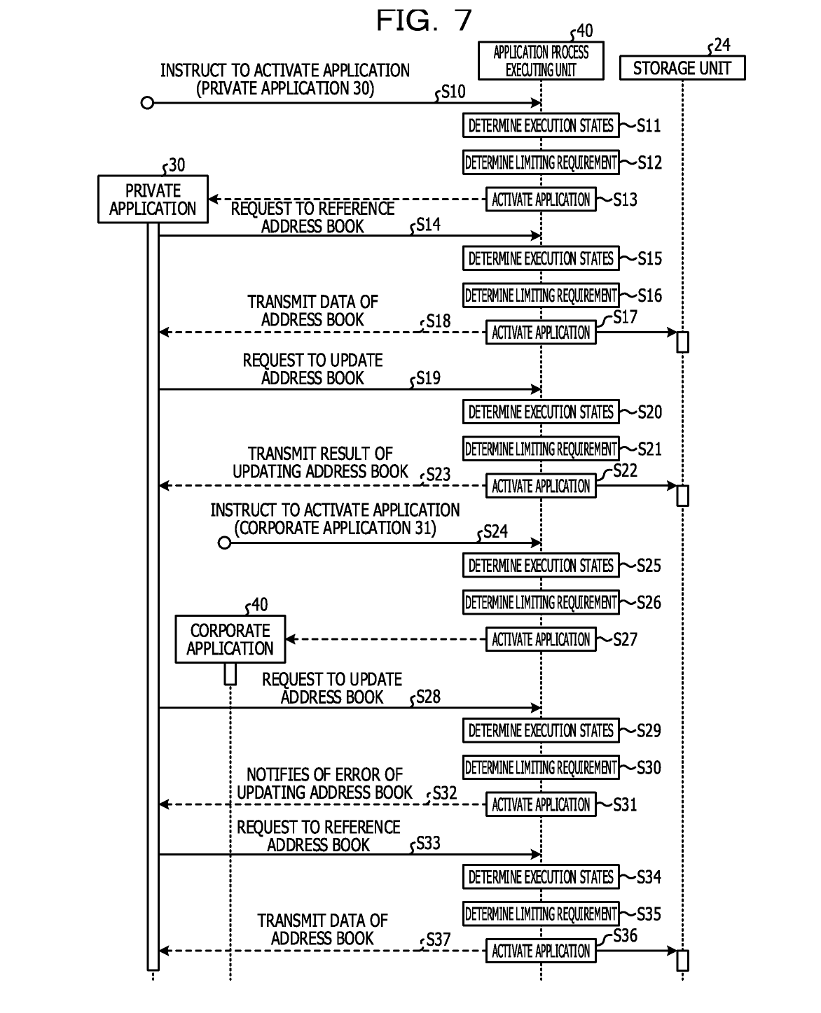

Next, the flows of various processes to be executed by the information processing device 10 are described in detail. First, the flow of a process of limiting a function by the information processing device 10 is described in detail. FIG. 7 is a diagram illustrating an example of the flow of the process of limiting a function.

As illustrated in FIG. 7, when the application process executing unit 40 receives an instruction to activate a private application 30 (in S10), the determining unit 43 determines execution states of the corporate applications 31 (in S11). For example, the determining unit 43 determines the execution states of the corporate applications 31 by determining whether or not the corporate applications 31 have been registered in the executed application management table 33. The limiting unit 44 determines whether or not a limiting requirement that matches the limiting requirement table 34 exists (in S12). In this case, this example assumes that a corporate application 31 activated does not exist and the matching limiting requirement does not exist. In this case, the application process executing unit 40 activates the private application 30 instructed to be activated (in S13).

When the application process executing unit 40 receives a request to reference an address book from the private application 30 (in S14), the determining unit 43 determines the execution states of the corporate applications 31 (in S15). The limiting unit 44 determines whether or not a limiting requirement that matches the limiting requirement table 34 exists (in S16). In this case, this example assumes that a corporate application 31 activated does not exist and the matching limiting requirement does not exist. In this case, the application process executing unit 40 reads data of the address book requested to be referenced (in S17) and transmits the read data of the address book to the private application 30 (in S18).

When the application process executing unit 40 receives a request to update the address book from the private application 30 (in S19), the determining unit 43 determines the execution states of the corporate applications 31 (in S20). The limiting unit 44 determines whether or not a limiting requirement that matches the limiting requirement table 34 exists (in S21). In this case, this example assumes that a corporate application 31 activated does not exist and the matching limiting requirement does not exist. In this case, the application process executing unit 40 updates the data of the address book requested to be updated (in S22) and transmits a result of updating the address book to the private application 30 that has transmitted the request to update the address book (in S23).

When the application process executing unit 40 receives an instruction to activate a corporate application 31 (in S24), the determining unit 43 determines execution states of the private applications 30 (in S25). For example, the determining unit 43 determines the execution states of the private applications 30 by determining whether or not the private applications 30 have been registered in the executed application management table 33. The limiting unit 44 determines whether or not a limiting requirement that matches the limiting requirement table 34 exists (in S26). In this case, this example assumes that the private application 30 and a corporate application 31 are activated and a requirement for limiting the activation of an application does not exist. In this case, the application process executing unit 40 activates the corporate application 31 instructed to be activated (in S27).

When the application process executing unit 40 receives a request to update the address book from the private application 30 (in S28), the determining unit 43 determines the execution states of the corporate applications 31 (in S29). The limiting unit 44 determines whether or not a limiting requirement that matches the limiting requirement table 34 exists (in S30). In this case, this example assumes that the private application 30 and the corporate applications 31 are activated and a requirement for limiting updating of the address book exists. In this case, the limiting unit 44 limits the updating of the data of the address book requested to be updated (in S31) and notifies, of an error of updating the address book, the private application 30 that has transmitted the request to update the address book.

When the application process executing unit 40 receives a request to reference the address book from the private application (in S33), the determining unit 43 determines the execution states of the corporate applications (in S34). The limiting unit 44 determines whether or not a limiting requirement that matches the limiting requirement table 34 exists (in S35). In this case, this example assumes that the private application 30 and the corporate applications 31 are activated and a requirement for limiting reading of data does not exist. In this case, the application process executing unit 40 reads the data of the address book requested to be referenced (in S36) and transmits the read data of the address book to the private application 30 (in S37).

In this manner, the information processing device 10 may use a private application 30 and a corporate application 31 without switching modes, enable the user to perform both private and corporate tasks, and thus improve the usability for the user. In addition, the information processing device 10 limits a function, included in a private application 30, of updating data during the execution of a corporate application 31. Thus, the information processing device 10 may suppress the fact that corporate data used by a corporate application 31 is written by a private application 30, and the information processing device 10 may secure the security.

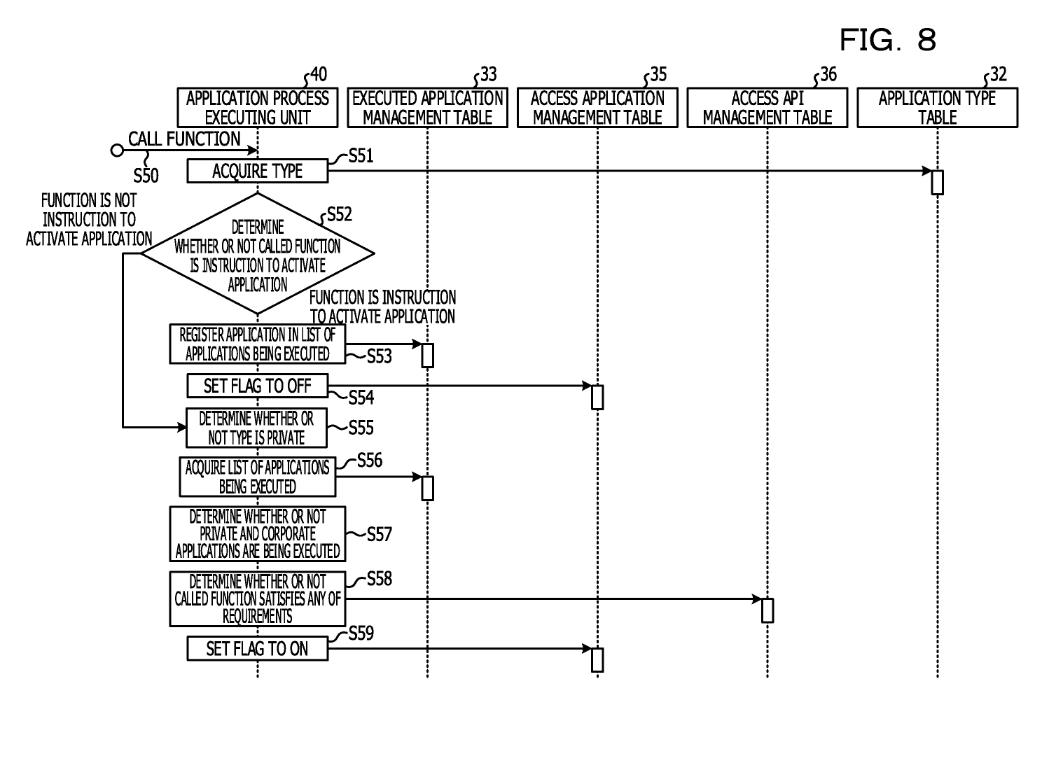

Next, the flow of a process of updating the access application management table 35 by the information processing device 10 is described in detail. FIG. 8 is a diagram illustrating an example of the flow of the update process.

As illustrated in FIG. 8, when the application process executing unit 40 receives a call of a function such as an API (in S50), the identifying unit 41 identifies whether an application that has called the function is a private application 30 or a corporate application 31. For example, the identifying unit 41 acquires, from the application type table 32, the type of the application that has called the function (in S51) and the identifying unit 41 identifies whether the application that has called the function is a private application 30 or a corporate application 31.

The updating unit 42 determines whether or not the called function is an instruction to activate an application (in S52). If the called function is the instruction to activate the application, the updating unit 42 registers the application to be activated in the executed application management table 33 (in S53), registers the application to be activated in the access application management table 35 so as to ensure that an access flag for the application to be activated represents “OFF” (in S54). Then, the updating unit 42 causes the process to proceed to S55. The updating unit 42 determines whether or not the application that has called the function is a private application 30 (in S55). In this case, this example assumes that the application that has called the function is a private application 30. In this case, the updating unit 42 acquires, from the executed application management table 33, a list of applications that are being executed (in S56). Then, the updating unit 42 determines whether or not a private application 30 and a corporate application 31 are being executed (in S57). In this case, this example assumes that a private application 30 and a corporate application 31 are being executed. In this case, the updating unit 42 determines whether or not the called function satisfies any of requirements registered in records of the access API management table 36 (in S58). In this case, this example assumes that the called function satisfies any of the requirements registered in the records of the access API management table 36. In this case, the updating unit 42 registers the private application 30 that has called the function in the access application management table 35 so as to ensure that an access flag for the private application 30 that has called the function represents “ON” (in S59).

Thus, the updating unit 42 registers a private application 30 that may have accessed corporate data in the access application management table 35 so as to ensure that an access flag for the private application 30 represents “ON”.

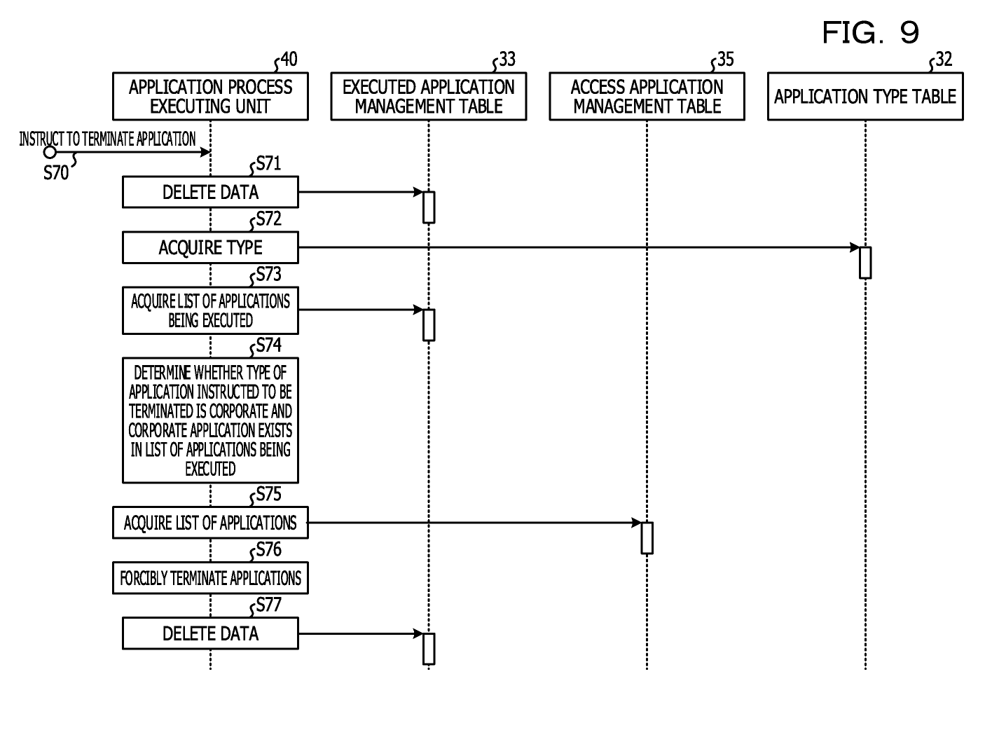

Next, the flow of a process of forcibly terminating an application by the information processing device 10 is described in detail. FIG. 9 is a diagram illustrating an example of the flow of the process of forcibly terminating an application.

As illustrated in FIG. 9, when receiving an instruction to terminate an application (in S70), the application process executing unit 40 deletes, from the executed application management table 33, a record related to the application instructed to be terminated (in S71). The identifying unit 41 identifies whether the application instructed to be terminated is a private application 30 or a corporate application 31. For example, the identifying unit 41 acquires, from the application type table 32, the type of the application instructed to be terminated (in S72) and identifies whether the application instructed to be terminated is a private application 30 or a corporate application 31.

The forcibly terminating unit 45 acquires, from the executed application management table 33, a list of applications that are being executed (in S73). Then, the forcibly terminating unit 45 determines whether or not the application instructed to be terminated is a corporate application 31 and whether or not another corporate application 31 that is being executed exists (in S74). In this case, this example assumes that the application instructed to be terminated is a corporate application 31 and another corporate application 31 that is being executed does not exist. In this case, the forcibly terminating unit 45 acquires, from the access application management table 35, a list of private applications 30 of which information has been stored and for which access flags for the private applications 30 represent “ON” (in S75). The forcibly terminating unit 45 forcibly terminates the private applications 30 of which the list has been acquired (in S76). The updating unit 42 deletes, from the executed application management table 33, records related to the private applications forcibly terminated (in S77).

When the information processing device 10 terminates all corporate applications 31, limits on functions of private applications 30 are released and data may be written. Thus, in order to terminate all the corporate applications 31, the information processing device 10 forcibly terminates a private application 30 that may have accessed corporate data and the information processing device 10 releases data held in a storage region used by the private application 30. Thus, the information processing device 10 may release data even when corporate data is held in a storage region used by a private application 30. The information processing device 10, therefore, may secure the security.

As described above, when a request to execute a certain private application 30 or a certain corporate application 31 is provided, the information processing device 10 according to the present embodiment determines an execution state of the other private or corporate application. Then, the information processing device 10 limits a function of the requested application based on the execution state of the other application. Thus, the information processing device 10 may improve the usability.

In addition, the information processing device 10 limits at least any of reading and writing of data by the requested application. Thus, the information processing device 10 may secure the security.

In addition, the information processing device 10 limits at least one of the amount of data to be read by the requested application and the amount of data to be written by the requested application. Thus, the information processing device 10 may improve the usability while suppressing a reduction in the security.

When a request to execute a private application 30 is provided, the information processing device 10 determines execution states of the corporate applications 31. Then, when a corporate application 31 is being executed, the information processing device 10 limits at least any of reading and writing of data by the private application 30. Thus, the information processing device 10 may secure the security for corporate data.

The information processing device 10 stores information of a private application 30 that may have accessed corporate data to be used for work by the user. When a corporate application 31 is terminated, the information processing device 10 forcibly terminates the private application 30 of which the information has been stored. Thus, even when corporate data is held in a storage region used by the private application 30, the information processing device 10 may release data and secure the security.

### Second Embodiment

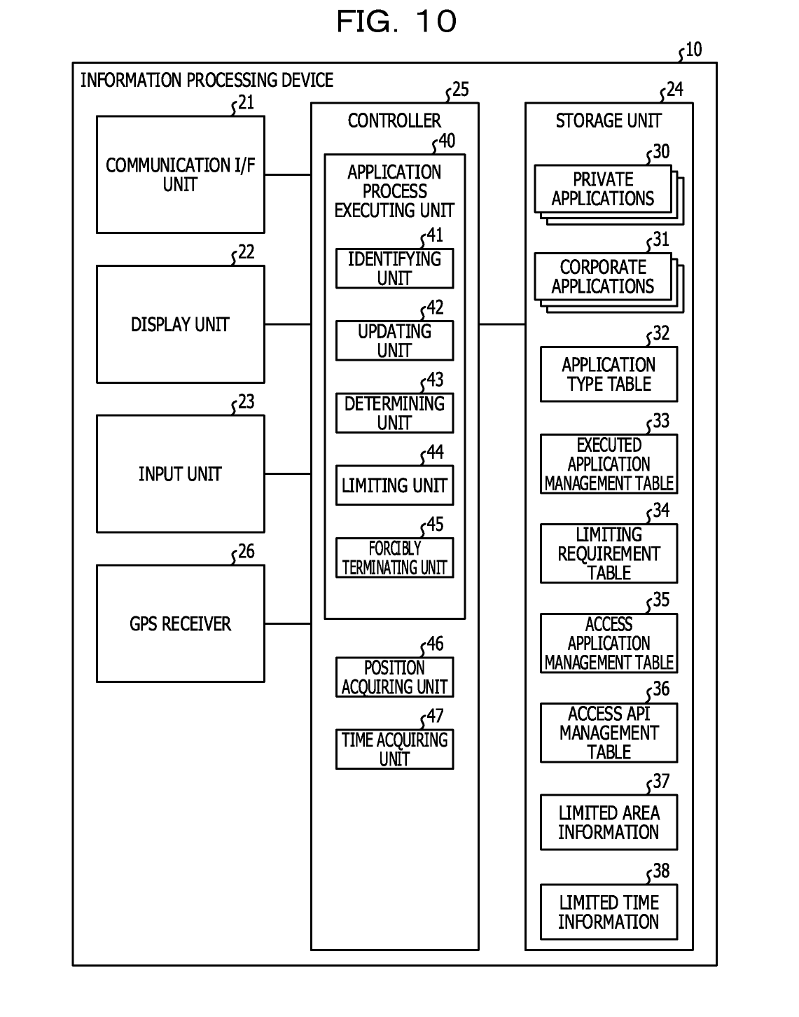

Next, a second embodiment is described. FIG. 10 is a diagram illustrating a functional configuration of the information processing device 10 according to the second embodiment. Since a configuration of the information processing device 10 according to the second embodiment is substantially the same as the first embodiment, parts that are the same as those described in the first embodiment are represented by the same reference numerals as those described in the first embodiment, and parts that are different from the first embodiment are mainly described below in the second embodiment.

As illustrated in FIG. 10, the information processing device 10 according to the second embodiment further includes a GPS receiver 26. The GPS receiver 26 receives radio waves including time information from a plurality of GPS satellites, calculates distances between the GPS receiver 26 and the GPS satellites, and measures coordinate values such as a longitude and a latitude.

The storage unit 24 further stores limited area information 37 and limited time information 38.

The limited area information 37 is data storing information that represents a limited area in which the use of the private applications 30 is limited. For example, the limited area information 37 represents, as the limited area, information of a range of an office used for work by the user and owned by the company for which the user works.

The limited time information 38 is data storing information of a limited time zone in which the use of the private applications 30 is limited. For example, the limited time information 38 represents, as the limited time zone, information of working hours of the user in the company.

The controller 25 further includes a position acquiring unit 46 and a time acquiring unit 47.

The position acquiring unit 46 acquires a current position of the information processing device 10. For example, the position acquiring unit 46 periodically acquires information of the current position measured by the GPS receiver 26 and represented by a longitude and a latitude.

The time acquiring unit 47 acquires a current time. For example, the time acquiring unit 47 acquires the current time from the time information included in the radio waves received by the GPS receiver 26. If the information processing device 10 has a time clock that is a real time clock (RTC) circuit or the like and presents the time, the time acquiring unit 47 may acquire the current time from the time clock. If the information processing device 10 has a receiver for receiving a standard radio wave including the time information, the time acquiring unit 47 may acquire the current time from a time indicated by the standard radio wave received.

The limiting unit 44 limits a function of an application based on the current position or the current time. For example, the limiting unit 44 limits a function of a private application 30 based on the current position acquired by the position acquiring unit 46 relative to the limited area represented by the limited area information 37. As an example, if the current position is within the office used for work by the user, the limiting unit 44 limits a function of a private application 30.

For example, the limiting unit 44 limits a function of a private application 30 based on the current time acquired by the time acquiring unit 47 relative to the working hours stored in the limited time information 38. As an example, if the current time is within the working hours of the user, the limiting unit 44 limits a function of a private application 30.

The limiting unit 44 may use stepwise transition areas in order to cause the function limiting to smoothly transmit. For example, information that represents a transition area located around the limited area is stored in the limited area information 37. For example, a hall located around the office used for work by the user is stored as a transition area in the limited area information 37. The limiting unit 44 gradually limits a function of a private application 30. For example, as a transmission area in which the information processing device 10 is located is closer to the limited area, a level at which the limiting unit 44 limits a function of a private application 30 is higher. For example, the limiting unit 44 may prohibit private phone calls in the office and may not limit the use of a phone application on the corridor located around the office. The limiting unit 44 may change details of the function limiting based on the transition of the current position of the information processing device 10. For example, the limiting unit 44 may limit applications so as to ensure that an application permitted to be used when the information processing device 10 is moved from the office to the corridor is different from an application permitted to be used when the information processing device 10 is moved to the corridor from another location. In addition, the limiting unit 44 may limit functions of applications so as to ensure that an application permitted to be used when the information processing device 10 is moved from the office to the corridor is different from an application permitted to be used when the information processing device 10 is moved to the corridor from another location. As an example, when the information processing device 10 is moved to the corridor from the inside of the office, the limiting unit 44 permits Exchange Server to continuously write data and permits Google Calendar to be referenced only. When the information processing device 10 is moved to the corridor from another location, the limiting unit 44 permits Google Calendar to continuously write data and permits Exchanger Server to be referenced only.

The limiting unit 44 may use stepwise transition times in order to cause the function limiting to smoothly transmit. For example, information of a break time within the working hours is further stored in the limited time information 38. The limiting unit 44 gradually limits a function of a private application 30. For example, the limiting unit 44 sets a level of limiting the function for time periods of 5 minutes immediately before and after the recess time to a lower level than a level of limiting the function for the working hours excluding the time periods and the recess time, and sets a level of limiting the function for the recess time to a lower level than the level of limiting the function for the time periods. For example, the limiting unit 44 may prohibit private phone calls during the working hours and limit the use of the phone application for the time periods of 5 minutes immediately before and after the recess time.

As described above, the information processing device 10 according to the present embodiment acquires the current position. The information processing device 10 limits at least any of reading and writing of data by a private application 30 based on the current position relative to the limited area stored in the limited area information 37. Thus, when the current position is within the office, the information processing device 10 may limit a function of the private application 30 and thereby limit the use of the private application 30.

The information processing device 10 acquires the current time. The information processing device 10 limits at least any of reading and writing of data by a private application 30 based on the current time relative to the working hours stored in the limited time information 38. Thus, when the current time is within the working hours, the information processing device 10 may limit a function of the private application 30 and thereby limits the use of the private application 30.

### Third Embodiment

Although the embodiments related to the device disclosed herein are described above, the techniques disclosed herein may be achieved in various embodiments other than the aforementioned embodiments. Thus, another embodiment is described below.

For example, the aforementioned embodiments describe the case where when a private application 30 and a corporate application 31 are being executed, the information processing device 10 limits a function of the private application 30. The device disclosed herein, however, is not limited to this. For example, when a private application 30 and a corporate application 31 are being executed, the information processing device 10 may limit a function of the corporate application 31. For example, when a private application 30 and a corporate application 31 are being executed, the information processing device 10 may limit the amount of data able to be read by the corporate application 31 to a predetermined amount or less.

The aforementioned embodiments describe the case where the information processing device 10 forcibly terminates a private application 30 that may have accessed corporate data. The device disclosed herein, however, is not limited to this. For example, when all the corporate applications 31 are terminated, the information processing device 10 may terminate all the private applications 30. Information of a private application 30 that is able to access corporate data may be registered in the storage unit 24 in advance, and the information processing device 10 may forcibly terminate the registered private application 30 when all the corporate applications 31 are terminated.

The constituent elements of the information processing device are conceptual functions and may not be configured in the manners illustrated in the drawings. Specifically, the detailed separations and integrations of the device are not limited to the drawings. All or a part of the constituent elements of the device may be functionally or physically separated and integrated on an arbitrary basis based on loads and usage states of the constituent elements. For example, the processing units of the information processing device 10 that are the identifying unit 41, the updating unit 42, the determining unit 43, the limiting unit 44, the forcibly terminating unit 45, the position acquiring unit 46, and the time acquiring unit 47 may be integrated with each other. In addition, the processes of the processing units of the information processing device 10 may be separated into processes of a plurality of processing units. In addition, all or an arbitrary part of the processing functions that are executed by the processing units may be achieved by a CPU and a program to be analyzed and executed by the CPU or may be achieved by hardware using wired logic.

(Function Limiting Program)

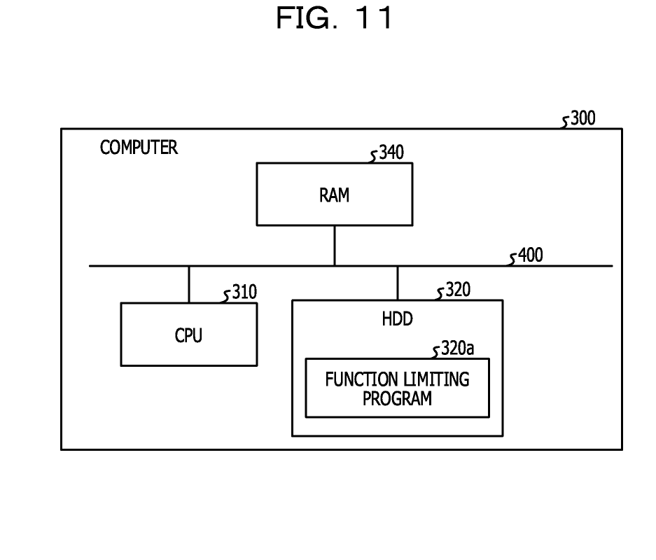

The various processes described in the embodiments may be achieved by causing a computer system such as a personal computer or a workstation to execute a program prepared in advance. An example of the computer system configured to execute the program including the same functions as described in the embodiments is described below. FIG. 11 is a diagram illustrating a computer configured to execute the function limiting program.

As illustrated in FIG. 11, the computer 300 includes a central processing unit (CPU) 310, a hard disk drive (HDD) 320, and a random access memory (RAM) 340. The CPU 310, the HDD 320, and the RAM 340 are connected to each other through a bus 400.

The HDD 320 has, stored therein, the function limiting program 320a that has the same functions as the identifying unit 41, updating unit 42, determining unit 43, limiting unit 44, forcibly terminating unit 45, position acquiring unit 46, and time acquiring unit 47 of the information processing device 10. The function limiting program 320a may be separated into parts.

The HDD 320 has, stored therein, various types of information to be used for the function limiting.

The CPU 310 reads the function limiting program 320a from the HDD 320, loads the function limiting program 320a into the RAM 340, and executes the processes using various types of data stored in the HDD 320. Specifically, the function limiting program 320a executes the same operations as the identifying unit 41, updating unit 42, determining unit 43, limiting unit 44, forcibly terminating unit 45, position acquiring unit 46, and time acquiring unit 47 of the information processing device 10.

The function limiting program 320a may not be stored in the HDD 320 in advance.

For example, the function limiting program 320a may be stored in a “portable physical medium” inserted in the computer 300. The portable physical medium is, for example, a flexible disk (FD), a CD-ROM, a DVD, a magneto-optical disc, an IC card, or the like. The computer 300 may read the function limiting program 320a from the portable physical medium and execute the function limiting program 320a.

In addition, the function limiting program 320a may be stored in “another computer (or server)” connected to the computer 300 through a public line, the Internet, a LAN, a WAN, or the like. The computer 300 may read the function limiting program 320a from the other computer and execute the function limiting program 320a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a processor; and
a memory which stores a plurality of instructions, which when executed by the processor, cause the processor to execute,
determining, when an execution of one of a first application and a second application is requested, an execution state of the other of the first application and the second application; and
limiting a function of the requested application based on the execution state of the other application.

2. The device according to claim 1,
wherein the limiting is to limit at least any of reading and writing of data by the requested application.

3. The device according to claim 1,
wherein the limiting is to limit at least one of the amount of data to be read by the requested application and the amount of data to be written by the requested application.

4. The device according to claim 1,
wherein the determining is to determine the execution state of the second application when the execution of the first application is provided, and
wherein the limiting is to limit at least any of reading and writing of data by the first application when the second application is executed.

5. The device according to claim 1, further comprising:
storing, in an access application storage unit, information of the first application that may have accessed corporate data to be used for work by the user; and
forcibly terminating the first application of which the information has been stored in the access application storage unit when the second application is terminated.

6. The device according to claim 4, further comprising:
acquiring a current position; and
storing, in a limited area storage unit, a limited area in which the use of the first application is limited,
wherein the limiting is to limit at least any of the reading and writing of data by the first application based on the current position acquired relative to the limited area stored in the limited area storage unit.

7. The device according to claim 4, further comprising:
acquiring a current time; and
storing working hours of the user in a limited time storage unit,
wherein the limiting is to limit at least any of the reading and writing of data by the first application based on the current time acquired relative to the working hours stored in the limited time storage unit.

8. A method for limiting a function, comprising:
determining, when an execution of one of a first application and a second application is requested, an execution state of the other of the first application and the second application; and
limiting, by a computer processer, a function of the requested application based on the execution state of the other application.

9. The method according to claim 8,
wherein the limiting is to limit at least any of reading and writing of data by the requested application.

10. The method according to claim 8,
wherein the limiting is to limit at least one of the amount of data to be read by the requested application and the amount of data to be written by the requested application.

11. The method according to claim 8,
wherein the determining is to determine the execution state of the second application when the execution of the first application is provided, and
wherein the limiting is to limit at least any of reading and writing of data by the first application when the second application is executed.

12. The method according to claim 8, further comprising:
storing, in an access application storage unit, information of the first application that may have accessed corporate data to be used for work by the user; and
forcibly terminating the first application of which the information has been stored in the access application storage unit when the second application is terminated.

13. The method according to claim 11, further comprising:
acquiring a current position; and
storing, in a limited area storage unit, a limited area in which the use of the first application is limited,
wherein the limiting is to limit at least any of the reading and writing of data by the first application based on the current position acquired relative to the limited area stored in the limited area storage unit.

14. The method according to claim 11, further comprising:
acquiring a current time; and
storing working hours of the user in a limited time storage unit,
wherein the limiting is to limit at least any of the reading and writing of data by the first application based on the current time acquired relative to the working hours stored in the limited time storage unit.

15. A computer-readable storage medium storing a function limiting program causing a computer to execute a process comprising:
determining, when an execution of one of a first application and a second application is requested, an execution state of the other of the first application and the second application; and
limiting a function of the requested application based on the execution state of the other application.
